(19) United States
(12) Patent Application Publication
(10) Pub. No.: US 2016/0170510 A1
(43) Pub. Date: Jun. 16, 2016

(54) TOUCH CONTROL DEVICE FOR ELECTRIC FIREPLACE

(71) Applicant: DONG GUAN SONG WEI ELECTRIC TECHNOLOGY CO., LTD, Dongguan City (CN)

(72) Inventor: Weilin LU, Dongguan City (CN)

(21) Appl. No.: 14/569,626

(22) Filed: Dec. 12, 2014

(51) Int. Cl. G06F 3/041; F21V 23/04; F21K 99/00

(52) U.S. Cl. CPC G06F 3/041; F21K 9/52; F21V 23/0485; G06F 2203/04103; F21Y 2101/02

(57) ABSTRACT

A touch control device for an electric fireplace includes a touch control panel, a face shell, a sensing electrode, an LED light, and a light guide cover. The face shell is installed on the touch control panel. An accommodation space is defined between the face shell and the touch control panel. The inner surface of the face shell is provided with a silkscreen layer for showing button information. When the LED light is turned on, the light guide cover blocks the LED light from shining directly to form even light. The even light projects on the silkscreen layer, such that the button pattern can be seen clearly from the front of the face shell. When the LED light on the touch control panel is turned off, the button pattern will disappear from the front of the face shell to achieve the purpose of hidden buttons.

### BACKGROUND OF THE INVENTION

1. Field of the Invention

The present invention relates to an electric fireplace, and more particularly to a touch control device for an electric fireplace.

2. Description of the Prior Art

In the early days, a fireplace can be used for lighting, warming, baking. With the development of economy and technology, the three functions of lighting, warming, baking are gradually improved and separated. These days, a fireplace becomes warming equipment.

With the development of times, fireplaces are improved from the traditional fireplaces, such as wood burning fireplaces, fuel gas fireplaces or charcoal fireplaces, to electric fireplaces. The electric fireplaces come from the European classical fireplaces to cooperate with acoustics and optics technique to make a great change for the traditional fireplaces. The electric fireplaces are green and friendly-environmental and provide a realistic burning effect.

In these days, electric fireplaces are rapidly developed to substitute the traditional fireplaces. A conventional electric fireplace is provided with an illuminating device to radiate light. The light is reflected to form flame-shaped light to be projected on an image screen. However, the conventional electric fireplace is provided with mechanical buttons. It is not easy to design the mechanical buttons. The mechanical buttons cannot be hidden. This causes the appearance of the electric fireplace is not pleasing. Accordingly, the inventor of the present invention has devoted himself based on his many years of practical experiences to solve this problem.

### SUMMARY OF THE INVENTION

The primary object of the present invention is to provide a touch control device for an electric fireplace to overcome the shortcomings of the existing electric fireplace.

In order to achieve the aforesaid object, the touch control device for an electric fireplace of the present invention comprises a touch control panel, a face shell, a sensing electrode, an LED (light emitting diode) light, and a light guide cover. The touch control panel comprises a master control unit (MCU), a touch sensing unit, an LED control unit, and a receiver. The touch sensing unit, the LED control unit, and the receiver are connected with the master control unit. The face shell is installed on the touch control panel. An accommodation space is defined between the face shell and the touch control panel. The inner surface of the face shell is provided with a silkscreen layer for showing button information. The sensing electrode is disposed on the touch control panel and located in the accommodation space. One end of the sensing electrode is connected with the touch sensing unit. Another end of the sensing electrode is attached to the inner surface of the face shell. The LED light is disposed on the touch control panel and located in the accommodation space. The LED light is connected with the LED control unit. The light guide cover is disposed on the LED light to block the LED light from shining directly. The light guide cover is located in the accommodation space and faces the silkscreen layer.

Compared to the prior art, the present invention has obvious advantages and beneficial effects. Through the light guide cover, the light guide cover blocks the LED light from shining directly to form even light when the LED light is turned on. The even light projects on the silkscreen layer, such that the button pattern can be seen clearly from the front of the face shell. When the LED light on the touch control panel is turned off, the button pattern will disappear from the front of the face shell to achieve the purpose of hidden buttons. There is no need for a mechanical external force control. The operation buttons of the electric fireplace can be designed easily, which is beneficial for the appearance of the electric fireplace. The innovative design for the buttons changes the design of the traditional mechanical buttons, having great significance.

### BRIEF DESCRIPTION OF THE DRAWINGS

FIG. 1 is an exploded view according to a preferred embodiment of the present invention when in use;

FIG. 2 is an exploded view according to the preferred embodiment of the present invention;

FIG. 3 is a sectional view according to the preferred embodiment of the present invention; and

FIG. 4 is a block diagram showing the circuit of the preferred embodiment of the present invention.

### DETAILED DESCRIPTION OF THE PREFERRED EMBODIMENTS

Embodiments of the present invention will now be described, by way of example only, with reference to the accompanying drawings.

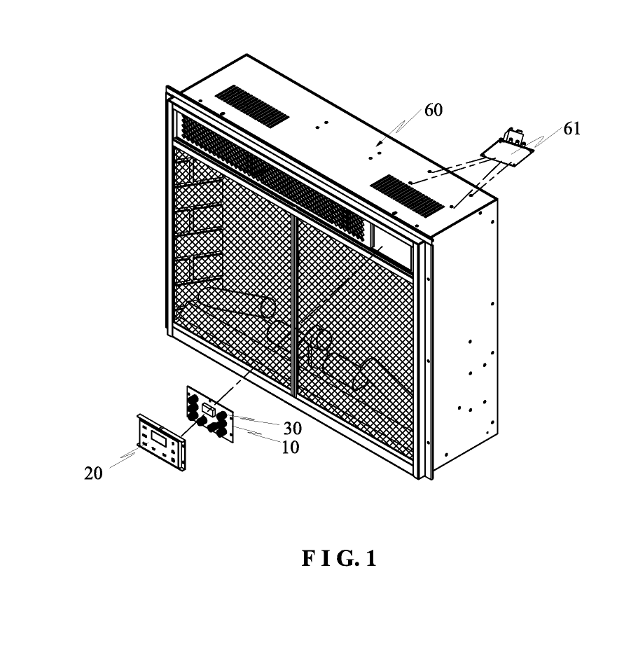

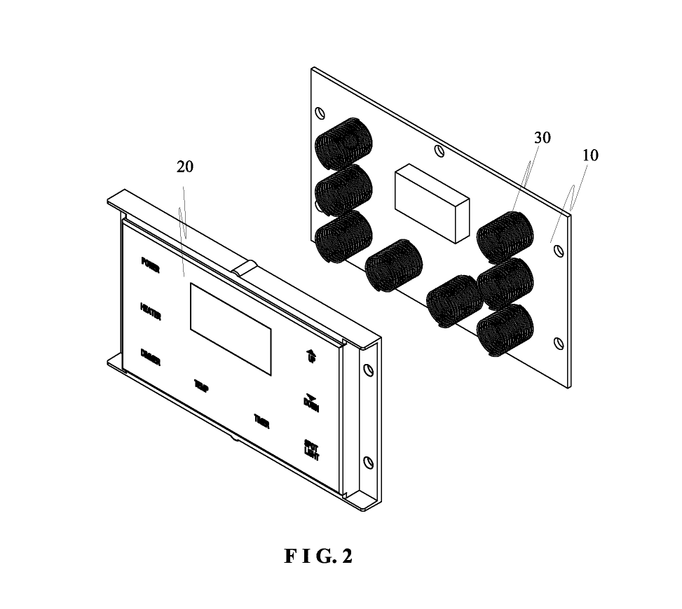

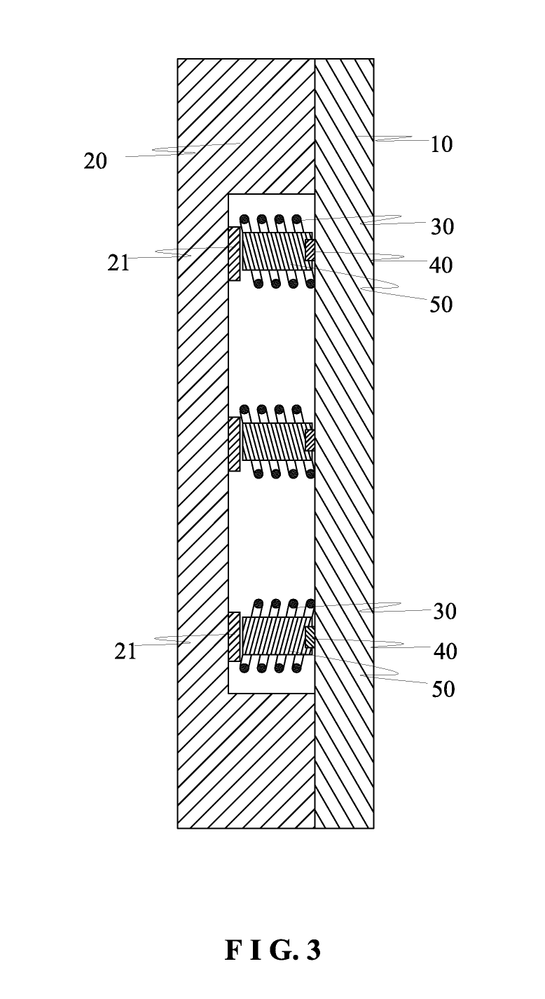

As shown in FIG. 1 to FIG. 4, the touch control device according to a preferred embodiment of the present invention comprises a touch control panel 10, a face shell 20, a sensing electrode 30, an LED (light emitting diode) light 40, and a light guide cover 50.

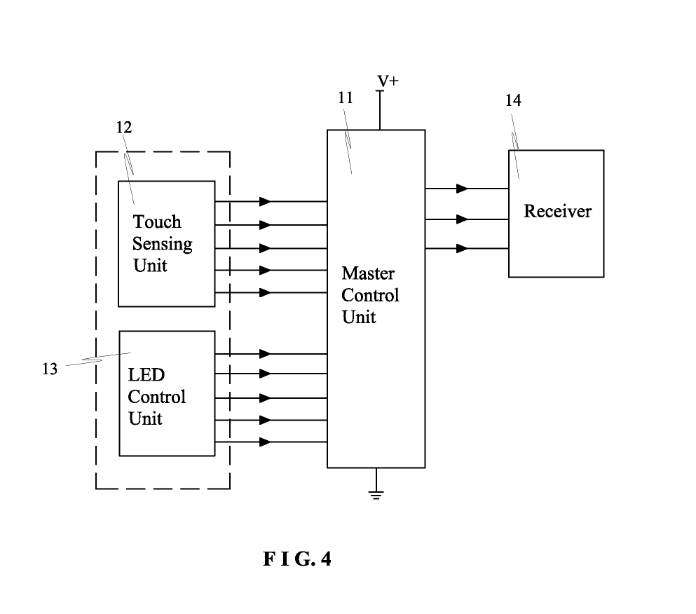

The touch control panel 10 comprises a master control unit (MCU) 11, a touch sensing unit 12, an LED control unit 13, and a receiver 14. As shown in FIG. 4, all the touch sensing unit 12, the LED control unit 13, and the receiver 14 are connected with the master control unit 11.

The face shell 20 is installed on the touch control panel 10. An accommodation space 101 is defined between the face shell 20 and the touch control panel 10. The inner surface of the face shell 20 is provided with a silkscreen layer 21 for showing button information. The silkscreen layer 21 is formed with various characters and symbols to show the patterns of all the buttons. In this embodiment, the face shell 20 is made of a plastic material or an acrylic material. The face shell 20 is in a translucent deep color. The silkscreen layer 20 is a white silkscreen layer.

The sensing electrode 30 is disposed on the touch control panel 10 and located in the accommodation space 101. One end of the sensing electrode 30 is connected with the touch sensing unit 12. Another end of the sensing electrode 30 is attached to the inner surface of the face shell 20. In this embodiment, the sensing electrode 30 is a spring. Two ends of the spring are against the surface of the touch control panel 10 and the inner surface of the face shell 20, respectively. The sensing electrode 30 can be a printed circuit board (not shown in the drawings). The printed circuit board is provided an electrode (not shown in the drawings) for conducting electricity by touch induction.

The LED light 40 is disposed on the touch control panel 10 and located in the accommodation space 101. The LED light 40 is connected with the LED control unit 13. The LED light 40 is a plug-in LED light or a SMD (surface-mount-device) LED. The way to encapsulate the LED light 40 is not limited to. The LED light 40 is to radiate red, yellow, green or blue light. Besides, the touch control panel 10 is connected with the master control unit 61 of the electric fireplace 60. The LED light 40 is controlled by the touch control panel 10 or the master control unit 61, such that to turn off the LED light 40 can be delayed better.

The light guide cover 50 is disposed on the LED light 40 to block the LED light 40 from shining directly. The light guide cover 50 is located in the accommodation space 101 and faces the silkscreen layer 21. In this embodiment, the light guide cover 50 is located in the spring. The characters and symbols in the silkscreen layer 21 have a diameter less than that of the spring.

Furthermore, in this embodiment, the touch control panel 10 comprises a plurality of LED lights 40 thereon. Each LED light 40 is provided with the light guide cover 50. The sensing electrode 30 is fitted on the light guide cover 50. The inner surface of the face shell 20 is formed with the silkscreen layer 21 corresponding in position to the light guide cover 50. A translucent window is formed between every two adjacent silkscreen layers 21 for transmitting the light of the LED light 40.

When in use, the LED light 40 on the touch control panel 10 shines and the light guide cover 50 blocks the LED light 40 from shining directly to form even light. The even light projects on the silkscreen layer 21, such that the button pattern can be seen clearly from the front of the face shell 20. When the LED light 40 on the touch control panel 10 is turned off, the button pattern will disappear from the front of the face shell 20 to achieve the purpose of hidden buttons.

The feature of the present invention is that through the light guide cover, the light guide cover blocks the LED light from shining directly to form even light when the LED light is turned on. The even light projects on the silkscreen layer, such that the button pattern can be seen clearly from the front of the face shell. When the LED light on the touch control panel is turned off, the button pattern will disappear from the front of the face shell to achieve the purpose of hidden buttons. There is no need for a mechanical external force control. The operation buttons of the electric fireplace can be designed easily, which is beneficial for the appearance of the electric fireplace. The innovative design for the buttons changes the design of the traditional mechanical buttons, having great significance.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A touch control device for an electric fireplace, comprising a touch control panel, a face shell, a sensing electrode, an LED (light emitting diode) light, and a light guide cover; the touch control panel comprising a master control unit (MCU), a touch sensing unit, an LED control unit, and a receiver, the touch sensing unit, the LED control unit, and the receiver being connected with the master control unit; the face shell being installed on the touch control panel, an accommodation space being defined between the face shell and the touch control panel, an inner surface of the face shell being provided with a silkscreen layer for showing button information; the sensing electrode being disposed on the touch control panel and located in the accommodation space, one end of the sensing electrode being connected with the touch sensing unit, another end of the sensing electrode being attached to the inner surface of the face shell; the LED light being disposed on the touch control panel and located in the accommodation space, the LED light being connected with the LED control unit; the light guide cover being disposed on the LED light to block the LED light from shining directly, the light guide cover being located in the accommodation space and facing the silkscreen layer.

2. The touch control device for an electric fireplace as claimed in claim 1, wherein the face shell is made of one of a plastic material and an acrylic material, and the face shell is in a translucent deep color.

3. The touch control device for an electric fireplace as claimed in claim 1, wherein the silkscreen layer is a white silkscreen layer.

4. The touch control device for an electric fireplace as claimed in claim 1, wherein the sensing electrode is a spring, two ends of the spring are against an surface of the touch control panel and the inner surface of the face shell respectively, the light guide cover is located in the spring, the silkscreen layer having characters and symbols therein, and the characters and symbols having a diameter less than that of the spring.

5. The touch control device for an electric fireplace as claimed in claim 1, wherein the sensing electrode is a printed circuit board, and the printed circuit board is provided an electrode thereon.

6. The touch control device for an electric fireplace as claimed in claim 1, wherein the LED light is to radiate red, yellow, green or blue light.

7. The touch control device for an electric fireplace as claimed in claim 1, wherein the LED light is one of a plug-in LED light and a SMD (surface-mount-device) LED.

8. The touch control device for an electric fireplace as claimed in claim 1, wherein the touch control panel is connected with the master control unit, and the LED light is controlled by the touch control panel or the master control unit.

9. The touch control device for an electric fireplace as claimed in claim 1, wherein the touch control panel comprises a plurality of LED lights thereon, each LED light is provided with the light guide cover, the sensing electrode is fitted on the light guide cover, the inner surface of the face shell being formed with the silkscreen layer corresponding in position to the light guide cover, and a translucent window is formed between every two adjacent silkscreen layers for transmitting the light of the LED light.
